(19) United States
(12) Patent Application Publication
(10) Pub. No.: US 2017/0341699 A1
(43) Pub. Date: Nov. 30, 2017

(54) STRADDLE-TYPE VEHICLE AND EXTERNAL MEMBERS THEREOF

(71) Applicant: Kawasaki Jukogyo Kabushiki Kaisha, Kobe-shi (JP)

(72) Inventors: Fumihiro Nakagawa, Kakogawa-shi (JP); Takahiro Osaki, Kobe-shi (JP); Yuuki Takahashi, Kakogawa-shi (JP)

(21) Appl. No.: 15/163,568

(22) Filed: May 24, 2016

(51) Int. Cl. B62K 19/16

(52) U.S. Cl. CPC B62K 19/16

(57) ABSTRACT

A straddle-type vehicle comprises an external member having an outer surface exposed to an outside of the straddle-type vehicle, the external member includes a base section and a coating section coated on the base section, the coating section includes a color layer, a metal coating layer stacked on the color layer, and a light transmission layer stacked on the metal coating layer and having the outer surface exposed to the outside of the straddle-type vehicle, and the outer surface of the light transmission layer comprises a self-restoring resin.

### BACKGROUND OF THE INVENTION

### Field of the Invention

The present invention relates to a straddle-type vehicle such as a motorcycle, and external members thereof.

### Description of Related Art

In an exemplary motorcycle disclosed in Japanese Laid-Open Patent Application Publication No. H5-76820, for example, external members mounted to its vehicle body, such as a fuel tank and cowlings, are coated to improve their external appearances.

In a straddle-type vehicle such as the motorcycle, a rider may sometimes rub the external member and thereby a scratch may be formed on a coated surface thereof. In the course of manufacturing steps of the straddle-type vehicle, the external member having the scratch formed on the coated surface thereof is determined as a defective product in an external appearance test, and sent to a scratch repair step. In particular, in a case where the color or the like of the external member makes the scratch formed on the coated surface noticeable, this external member may be determined as the defective product in the external appearance test, which reduces the manufacturing efficiency of the straddle-type vehicle.

### SUMMARY OF THE INVENTION

The present invention addresses the above-described conditions, and an object of the present invention is to maintain the good appearance of an external member of a straddle-type vehicle, and increase the manufacturing efficiency of the straddle-type vehicle.

According to an aspect of the present invention, a straddle-type vehicle comprises an external member having an outer surface exposed to an outside of the straddle-type vehicle, the external member includes a base section and a coating section coated on the base section, the coating section includes a color layer, a metal coating layer stacked on the color layer, and a light transmission layer stacked on the metal coating layer and having the outer surface exposed to the outside of the straddle-type vehicle, and the outer surface of the light transmission layer comprises a self-restoring resin.

In a case where a scratch is formed on the outer surface of the external member of the straddle-type vehicle, this scratch is easily noticed due to light reflected on the metal coating layer (e.g., a silver mirror coating layer). However, in accordance with the above-described configuration, the outer surface of the external member is naturally self-restored from the scratch to its original state, because of the elasticity of the self-restoring resin. Therefore, without carrying out maintenance work, the external appearance of the external member which is seen by a person can be kept in good condition, even in a state in which external light travels through the light transmission layer and is reflected by the metal coating layer. In addition, in the course of manufacturing steps of the straddle-type vehicle, the outer surface of the external member is self-restored from the scratch formed on the outer surface to its original state. In this way, a rejection rate with which the external member is determined as a defective product in the external appearance test step can be reduced. As a result, a scratch repair step for the defective product can be reduced, and the manufacturing efficiency of the straddle-type vehicle can be improved.

According to another aspect of the present invention, an external member having an outer surface exposed to the outside of a straddle-type vehicle comprises a base section; and a coating section coated on the base section, wherein the coating section includes a color layer, a metal coating layer stacked on the color layer, and a light transmission layer stacked on the metal coating layer and having the outer surface exposed to the outside of the straddle-type vehicle, and wherein the outer surface of the light transmission layer comprises a self-restoring resin.

In accordance with this configuration, as in the above configuration, the external appearance of the external member of the straddle-type vehicle can be kept in good condition, and the manufacturing efficiency of the straddle-type vehicle can be increased.

The above and further objects, features, and advantages of the present invention will more fully be apparent from the following detailed description of a preferred embodiment with reference to the accompanying drawings.

### BRIEF DESCRIPTION OF THE DRAWINGS

FIG. 1 is a side view of a motorcycle according to the embodiment of the present invention.

FIG. 2 is an enlarged cross-sectional view showing the major parts of a fuel tank of the motorcycle of FIG. 1.

FIG. 3 is an enlarged cross-sectional view of the major parts of a side cowling of the motorcycle of FIG. 1.

### DETAILED DESCRIPTION OF THE PREFERRED EMBODIMENTS

Hereinafter, the embodiment of the present invention will be described with reference to the drawings. The stated directions are from the perspective of a rider riding on a motorcycle.

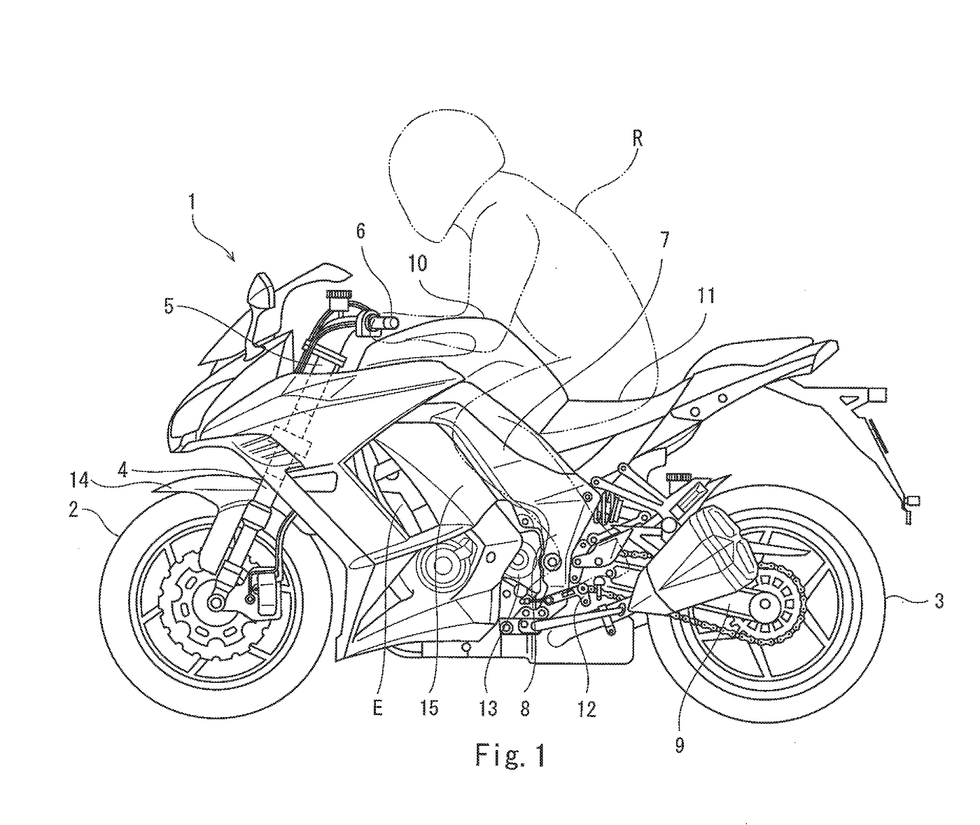

FIG. 1 is a side view of a motorcycle 1 according to the embodiment of the present invention. As shown in FIG. 1, the motorcycle 1 includes a front wheel 2 and a rear wheel 3. The front wheel 2 is connected to a front fork 4. The front fork 4 is mounted to a steering shaft (not shown) which is rotatably supported by a head pipe 5. A bar-type handle 6 which can be gripped by a rider R is attached to the steering shaft in such a manner that the handle 6 extends to the right and the left substantially in a vehicle width direction (rightward and leftward direction). To steer the motorcycle 1, the rider R steers the handle 6 to rotate the front wheel 2 via the steering shaft. A pair of right and left main frames 7 extend rearward from the head pipe 5 in such a manner that the main frames 7 are inclined in a downward direction. A pair of right and left pivot frames 8 are connected to the rear portions of the pair of main frames 7, respectively. The front end portions of a swing arm 9 are connected to the pivot frames 8 in such a manner that the swing arm 9 is pivotable. The rear wheel 3 is rotatably mounted to the rear end portion of the swing arm 9. A fuel tank 10 is placed rearward relative to the handle 6. A seat 11 which can be straddled by the rider R is placed behind the fuel tank 10.

At least a portion of the fuel tank 10 is located above the main frames 7. The fuel tank 10 is located in front of the seat 11 and adjacently to the seat 11. The fuel tank 10 protrudes farther upward than the seat 11 does. The fuel tank 10 has a shape in which a center portion in a forward and rearward direction swells to the right and the left. The lower rear portion of the fuel tank 10 is recessed in an inward direction of the vehicle width direction. More specifically, the dimension of the lower rear portion of the fuel tank 10 in the vehicle width direction is smaller than the dimension of the center portion of the fuel tank 10 in the forward and rearward direction. The rider R grips a part of the fuel tank 10, to be precise, the lower rear portion of the fuel tank 10, with the inner side portions of their legs, mainly their knees. Thus, in a state in which the posture of the rider R is stabilized, the rider R steers the motorcycle 1.

Foot rests 12 are provided on the right and left sides, below the seat 11, to allow the rider to place their feet thereon. Between the front wheel 2 and the rear wheel 3, an engine E is placed. The engine E is mounted to the main frames 7 and the pivot frames 8. A transmission 13 is connected to the output shaft of the engine E. Driving power is transmitted from the transmission 13 to the rear wheel 3 via a chain or a belt. The front wheel 2 is covered by a fender 14 from above. The fender 14 is located in front of the handle 6. A pair of cowlings 15 are placed to extend from a location that is in front of the head pipe 5 to locations that are outward in the rightward and leftward direction relative to the engine E. The fuel tank 10, the fender 14 and the pair of cowlings 15 are external members having outer surfaces exposed to the outside of the motorcycle 1. Each of the outer surface of the fuel tank 10 and the outer surfaces of the pair of cowlings 15 has a region located rearward relative to the handle 6 and in front of the seat 11.

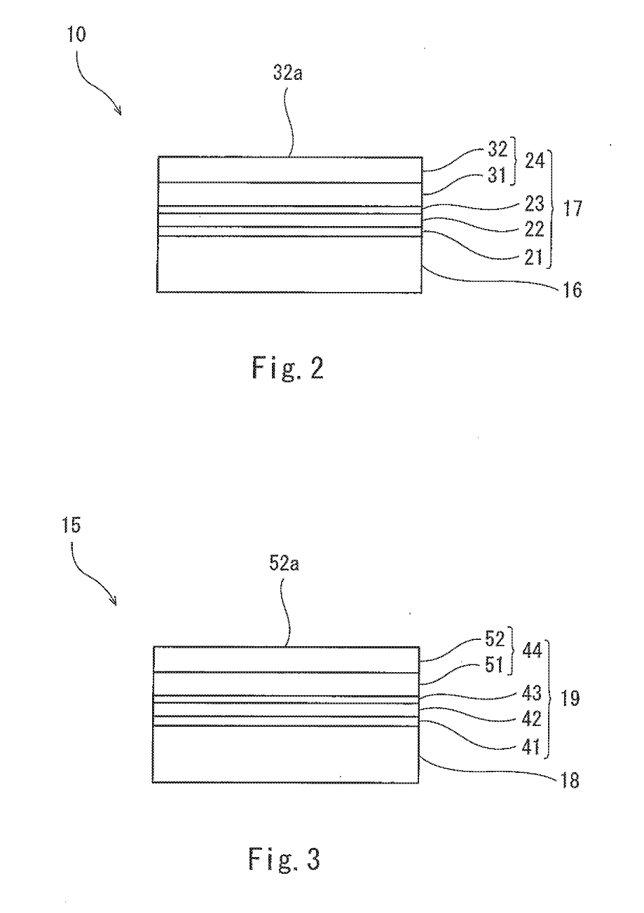

FIG. 2 is an enlarged cross-sectional view showing the major parts of the fuel tank 10 of the motorcycle 1 of FIG. 1. As shown in FIG. 2, the fuel tank 10 includes a base section 16 which is a metal container having a fuel reservoir[SG1][MA2], and a coating section 17 coated on the outer surface of the base section 16. The coating section 17 includes a primer layer 21, a color layer 22, a metal coating layer 23, and a light transmission layer 24, which are arranged in this order from the bottom to the top, and stacked together. The primer layer 21 is an under coating layer for preventing rusting of the base section 16 made of metal. The color layer 22 allows the fuel tank 10 to have a color and secures an adhesive state between the primer layer 21 and the metal coating layer 23. In the present embodiment, for example, the color layer 22 contains a pigment with a dark color (e.g., a black color or a navy color) having a brightness which is equal to or greater than 0% (0% or more) and less than 50%.

The metal coating layer 23 is a metal coating layer formed on the color layer 22. In the present embodiment, for example, the metal coating layer 23 is a silver mirror coating layer. Instead of the silver mirror coating layer, the metal coating layer 23 may be a plating layer comprising metal such as aluminum. The metal coating layer 23 is thinner than the color layer 22 and the light transmission layer 24. For example, the metal coating layer 23 has a thickness which is equal to or greater than 0.02 μm (0.02 μm or more), and is equal to or less than 0.1 μm (0.1 μm or less). In this configuration, when the metal coating layer 23 is externally seen, the color of the color layer 22 can be seen through the metal coating layer 23.

The light transmission layer 24 includes a first light transmission layer 31 as a lower layer and a second light transmission layer 32 as an upper layer, which are stacked together. The first light transmission layer 31 is a transparent coating agent layer comprising a non-self-restoring resin. This non-self-restoring resin has a characteristic in which when a pencil lead with a hardness of F or more is pressed against and moved on the outer surface of a resin layer comprising the non-self-restoring resin, in a scratch hardness test (pencil method) defined in Japanese Industrial Standard (JIS) K5600-5-4(1999), a scratch is formed on the outer surface of the resin layer and becomes a permanent indentation, and the outer surface of the resin layer is not restored from the scratch to its original state, after the passage of time. In the present embodiment, the first light transmission layer 31 comprises a mixture of a base resin (trade name: FG clear, product number: 4207-065782, SAITO PAINT CO., LTD.), and a curing (hardening) agent (trade name: FG clear curing agent, product number: 6508-0005784, SAITO PAINT CO., LTD.). The first light transmission layer 31 is thicker than the color layer 22. Between the first light transmission layer 31 and the metal coating layer 23, a silanol group for securing an adhesive state between the first light transmission layer 31 and the metal coating layer 23 is provided.

The second light transmission layer 32 is a transparent coating agent layer comprising a self-restoring resin. An outer surface 32a of the second light transmission layer 32 is an outer surface exposed to the outside of the fuel tank 10. This self-restoring resin has a characteristic in which the outer surface of a resin layer comprising the self-restoring resin is restored from a scratch to its original state because of the elasticity of the self-restoring resin, if the resin is deformed by a force externally applied and thereby the scratch is formed on the outer surface. For example, the self-restoring resin has a characteristic in which the outer surface of the resin layer can be restored from the scratch to its original state, when 10 to 20 minutes passes after the scratch is formed, in an environment in which an ambient temperature is 26 degrees C. The self-restoring resin preferably has a pencil hardness of 2B or more, more preferably B or more, in the scratch hardness test (pencil method) defined in JIS K5600-5-4(1999). In other words, the self-restoring resin preferably has a hardness characteristic in which no scratch is formed on the outer surface when the outer surface of the resin layer is scratched by the pencil with a hardness of 3B and a scratch is formed on the outer surface when the outer surface of the resin layer is scratched by the pencil with a hardness which is equal to or greater than 2B or B. Time required to self-restore the outer surface of the self-restoring resin with a pencil hardness of 2B from the scratch to its original state is shorter than time required to self-restore the outer surface of the self-restoring resin with a pencil hardness of B from the scratch to its original state. On other hand, the self-restoring resin with a pencil hardness of B is polished more uniformly than the self-restoring resin with a pencil hardness of 2B is, in the step of polishing the outer surface (self-restoring resin) before shipping of the motorcycle 1.

The self-restoring resin preferably has a pencil hardness of F or less, more preferably, HB or less, in the scratch hardness test (pencil method) defined in JIS K5600-5-4(1999). In the present embodiment, the second light transmission layer 32 is a mixture of a base resin (trade name: KJY31, NATOKO CO., LTD), and a curing agent (trade name: KJY31 curing agent, NATOKO CO., LTD). The second light transmission layer 32 is thicker than the color layer 22.

FIG. 3 is an enlarged cross-sectional view of the major parts of the side cowling 15 of the motorcycle of FIG. 1. The cowling 15 includes a base section 18 comprising a synthetic resin, and a coating section 19 coated on the outer surface of the base section 18. The coating section 19 includes an electrically-conductive primer layer 41, a color layer 42, a metal coating layer 43, and a light transmission layer 44 which are arranged in this order from the bottom to the top, and stacked together. The light transmission layer 44 includes a first light transmission layer 51 as a lower layer and a second light transmission layer 52 as an upper layer which are stacked together. An outer surface 52a of the second light transmission layer 52 is an outer surface exposed to the outside of the cowling 15. The electrically-conductive primer layer 41 is an under coating layer for providing an adhesive state between the base section 18 comprising the synthetic resin, and the color layer 42, and for electrostatically coating the color layer 42. The color layer 42, the metal coating layer 43, and the light transmission layer 44 of the cowling 15 are the same as the color layer 22, the metal coating layer 23, and the light transmission layer 24 of the fuel tank 10, respectively. The first light transmission layer 51 and the second light transmission layer 52 of the cowling 15 are the same as the first light transmission layer 31 and the second light transmission layer 32 of the fuel tank 10, respectively.

The outer surface of the external member which is placed in front of the handle 6 or rearward relative to the seat 11 may be formed of a transparent coating agent comprising the non-self-restoring resin. The outer surface of the external member in which the color layer of the coating section has a brightness that is equal to or greater than 50% (50% or more) and is equal to or less than 100% (100% or less) may be formed of a transparent coating agent comprising the non-self-restoring resin. For example, the outer surface of the fender 14 (see FIG. 1) may be formed of a transparent coating agent comprising the non-self-restoring resin. Specifically, the fender 14 may include a base section comprising a synthetic resin, and a coating section stacked on the base section, the coating section may include a color layer and a metal coating layer, and a light transmission layer stacked on the metal coating layer may comprise the non-self-restoring resin, without the self-restoring resin.

In a case where the scratch is formed on the outer surface 32a of the fuel tank 10 or the outer surface 52a of the cowling 15 of the motorcycle 1, this scratch is easily noted due to light reflected on the metal coating layer 23, 43. However, in accordance with the above-described configuration, because of the elasticity of the self-restoring resin of the second light transmission layer 32, 52, the outer surface 32a, 52a is naturally restored from the scratch to its original state. Therefore, without carrying out maintenance work, the external appearance of the external member which is seen by a person can be kept in good condition, even in a state in which the external light travels through the light transmission layer 24, 44 and is reflected on the metal coating layer 23, 43. In addition, in the course of manufacturing steps of the motorcycle 1, the outer surface 32a of the fuel tank 10 or the outer surface 52a of the cowling 15 is self-restored from the scratch formed on the outer surface 32a, 52a to its original state. Therefore, a rejection rate with which the external member is determined as a defective product in the external appearance test step can be reduced. As a result, a scratch repair step for the defective product is reduced, and the manufacturing efficiency of the motorcycle 1 can be improved.

Since the self-restoring resin has a pencil hardness that is preferably 2B or more, more preferably, B or more, it becomes possible to prevent a situation in which the outer surface 32a, 52a is soft and is polished non-uniformly, in the step for polishing the outer surface 32a of the fuel tank 10 or the outer surface 52a of the cowling 15, before shipping of the motorcycle 1. In the case where the self-restoring resin has a pencil hardness of 2B or more, it becomes possible to prevent a situation in which the scratch is easily formed on the outer surface 32a, 52a, due to a minor incident in the manufacturing steps of the motorcycle 1. This eliminates a need for work for repairing the scratch. As a result, a self-restoring ability, a polishing performance, and high work efficiency can be realized.

Since the self-restoring resin has a pencil hardness that is preferably F or less, more preferably, HB or less, it becomes possible to prevent a situation in which a long time passes from when the scratch is formed on the outer surface 32a, 52a until the outer surface 32a, 52a is self-restored from the scratch to its original state. Thus, it is highly probable that self-restoration of the outer surface 32a, 52a from the scratch formed in the manufacturing steps of the motorcycle 1 is completed before the external test step starts. Therefore, the rejection rate with which the external member is determined as the defective product in the external appearance test step can be further reduced, and the manufacturing efficiency of the motorcycle 1 can be further increased.

Since each of the outer surfaces 32a, 52a of the fuel tank 10 and the side cowling 15 which are placed in front of the seat 11 straddled by the rider R and rearward relative to the handle 6 gripped by the rider R has the self-restoring characteristic, the external appearance of the external member on which the scratch may be formed due to a friction with the rider's clothes or the like, while the rider R is riding on the motorcycle 1, can be kept in good condition.

Since each of color layer 22 of the fuel tank 10 and the color layer 42 of the cowling 15 has the dark color with a brightness which is equal to or greater than 0% (0% or more) and less than 50%, and the metal coating layer 23, 43 is thinner than the color layer 22, 42, the scratch formed on the outer surface 32a, 52a looks white and is easily noted. However, in accordance with the configuration of the present embodiment, the outer surface 32a, 52a is self-restored from the scratch to its original state, because of the elasticity of the self-restoring resin. Therefore, the configuration of the present embodiment has an advantage in that the external appearance of the external member can be kept in good condition, and the manufacturing efficiency of the motorcycle 1 can be increased.

Since the first light transmission layer 31, 51 comprises the non-self-restoring resin, and the second light transmission layer 32, 52 comprises the self-restoring resin, the self-restoring resin can be used only in the second light transmission layer 32, 52, while sufficiently absorbing ultraviolet rays of incident light and reflected light by use of the first light transmission layer 31, 52 and the second light transmission layer 32, 52. As a result, the amount of usage of the self-restoring resin can be reduced, while increasing the ability to absorb the ultraviolet rays.

In an alternative example, glittering particles may be dispersed in a region between the metal coating layer 23, 43 and the light transmission layer 24, 44 of the fuel tank 10 or the cowling 15. For example, aluminum flakes (small pieces of an aluminum foil), scale-like pieces of glass, pearl pieces (mica pieces), or a combination of these may be used, as the glittering particles. In this case, the scratch formed on the outer surface of the fuel tank 10 or the cowling 15 is easily noted due to the light reflected on the glittering particles. However, in accordance with the configuration of the present embodiment, the second light transmission layer 32, 52 is naturally self-restored from the scratch to its original state, because of the elasticity of the self-restoring resin. Therefore, the configuration of the present embodiment has an advantage in that the external appearance of the external member can be kept in good condition and the manufacturing efficiency of the motorcycle 1 can be increased.

Numerous improvements and alternative embodiments of the invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the scope of the invention. For example, the external member which is placed in front of the seat and rearward relative to the handle, and protrudes farther upward than the seat does may be a fuel tank cover. In a case where the motorcycle is an electric vehicle which does not include an internal combustion engine, the external member which is placed in front of the seat and rearward relative to the handle, and protrudes farther upward than the seat does, may be a dummy tank. Further, although the motorcycle is exemplarily described as the straddle-type vehicle, the straddle-type vehicle may be, for example, an all-terrain vehicle (ATV) or personal watercraft (PWC), so long as the straddle-type vehicle is a vehicle steered by the rider straddling the seat.

1. A straddle-type vehicle comprising:
an external member having an outer surface exposed to an outside of the straddle-type vehicle,
wherein the external member includes a base section and a coating section coated on the base section,
wherein the coating section includes a color layer, a metal coating layer stacked on the color layer, and a light transmission layer stacked on the metal coating layer and having the outer surface exposed to the outside of the straddle-type vehicle, and
wherein the outer surface of the light transmission layer comprises a self-restoring resin.

2. The straddle-type vehicle according to claim 1,
wherein the self-restoring resin has a pencil hardness that is equal to or greater than 2B.

3. The straddle-type vehicle according to claim 1,
wherein the self-restoring resin has a pencil hardness that is equal to or less than F.

4. The straddle-type vehicle according to claim 1,
wherein the outer surface of the external member includes a region that is located in front of a seat configured to be straddled by a rider and rearward relative to a handle gripped by the rider.

5. The straddle-type vehicle according to claim 1,
wherein the color layer has a dark color with a brightness that is equal to or greater than 0% and less than 50%, and
wherein the metal coating layer is thinner than the color layer having the dark color.

6. An external member having an outer surface exposed to an outside of a straddle-type vehicle, the external member comprising:
a base section; and
a coating section coated on the base section,
wherein the coating section includes a color layer, a metal coating layer stacked on the color layer, and a light transmission layer stacked on the metal coating layer and having the outer surface exposed to the outside of the straddle-type vehicle, and
wherein the outer surface of the light transmission layer comprises a self-restoring resin.
